(19) United States
(12) Patent Application Publication
(10) Pub. No.: US 2015/0379191 A1
(43) Pub. Date: Dec. 31, 2015

(54) Method of identifying descendant animals by their relationship to an ancestor, or ancestors, in such a way that all descendants with a specified relationship to any choice of ancestor, or blend of ancestors, can be identified from within a collection of generational records.

(71) Applicant: Samuel Johnson, Mt. Vernon, WA (US)

(72) Inventor: Samuel Johnson, Mt. Vernon, WA (US)

(21) Appl. No.: 14/668,960

(22) Filed: Mar. 25, 2015

Related U.S. Application Data
(60) Provisional application No. 61/969,831, filed on Mar. 25, 2014.

(51) Int. Cl. G06F 19/14

(52) U.S. Cl. CPC G06F 19/14

(57) ABSTRACT

This invention inspects animal breeding records to identify descendants of any chosen ancestor and annotates information about each descendant's relatedness to the chosen ancestor. This information can be compiled for multiple ancestors and thereby creates the basis for a means of discovering all of the descendants who represent any blend of ancestor elements in whatever amount of relationship to those ancestors is specified by the researcher. It is made most useful in conjunction with database records, the internet and graphical user interfaces. Bloodline and pedigree researchers can make comprehensive selection choices by utilizing the means specified herein.

### CROSS-REFERENCE TO RELATED APPLICATIONS

This utility application claims the priority date benefit of U.S. Provisional Application 61/969,831 filed on Mar. 25, 2014.

### BACKGROUND OF THE INVENTION

Selective breeding is a hallmark of the domestication of animals, and has resulted in the collection of records to inform that selection. The invention described herein, improves the utility of those data collections through the application of technological advances, to the ends of aiding in the selection process.

Pedigree research is a traditional approach to utilizing the records collected by animal breeders. This method involves tracing lines of ancestry backwards in time from the animal being investigated and provides a way to see the familial inputs that have provided the genetics for that animal.

Because of an exponential increase in the number of ancestors represented by each succeeding generation (e.g. 2, 4, 8, 16, 32, 64, 128, etc.) the influence of animals far back in a pedigree become less accessible the further they regress into the past generations. Where animals are not much inter-related, there is little statistical chance that an animal far back in a pedigree has much relevance to the selection of living animals. But where selection has gone on long enough for a breed to form, some of those pedigree elements further removed generationally, can have a large cumulative genetic footprint. The awareness of much of this effect is lost in the volume of ancestors to be accounted for, when using the pedigree research method.

As well, the inter-relationship of various crosses between bloodlines becomes difficult to capture as the bloodline elements recede into generations past. Typically, the group of animals carrying a specific blend of family elements are difficult to conclusively identify beyond the third or fourth generation, and the blends considered are typically restricted to assess the crossing of just two bloodlines. To identify each animal in the population of interest, that represents the particular family blend being researched, pedigrees must be assembled and reviewed for every descendant on record that cannot be disqualified (e.g. by age, location, etc.). This is made particularly overwhelming because popular male animals often have hundreds, or even thousands, of first generation descendants. Because the sheer volume of data quickly escalates, breeders normally restrict their focus to the results of crosses involving two bloodlines carrying back two or three generations. The most common extensions beyond these limits are undertaken by identifying sub-breed groupings of animals by breeder (who may have bred many generations for certain characteristics) or pedigree element (e.g. animals that descend exclusively from a chosen subset of well-regarded animals from the past—which then may even form another breed) or simple male/female line of descent (e.g. mother, grandmother, great-grandmother, great-great-grandmother, etc.).

Therefore, this invention advances the state of the art by addressing the two limitations of pedigree research outlined above: 1) that there has been no practical way to comprehensively identify all of the animals descended from any chosen pedigree element, however many generations removed, along with the statistical proportion of influence garnered by each descendant to allow for comparison between descendants; and 2) neither has there been a practical way by which to identify all of the animals carrying a specified combination of bloodlines, in a specified amount (e.g. by statistical proportion of each bloodline element) of contribution.

### SUMMARY

The present invention is directed to a method of providing comprehensive analysis of generational breeding records to bring clarity to relationships previously obscured. Of particular focus is the ability of a user to identify all of the descendants strongly related to any particular progenitor, and the ability of a user to identify all descendants of a particular blend and relationship to chosen set of progenitors.

To identify all of the descendants strongly related to any particular progenitor, an embodiment of the present invention begins by having each descendant of the original progenitor inspected for descendants, and those descendants inspected for their own descendants, and so on, until each line of descent from the original progenitor has been inspected. Throughout this investigation, all descendants are recorded, for each line of descent in which they appear, and each record of descent is paired with an indicator of that descendant's relatedness to the original progenitor. The resulting records are presented, along with pertinent information about each descendant, to create a sortable list of descendants that can be organized by relationship to the original progenitor submitted for research.

If the bloodline researcher wants to identify all descendants of a particular blend and relationship to a chosen set of progenitors, an embodiment of the present invention collects records of descent for each chosen progenitor. Parameters set by the researcher are then utilized to join the resulting data collections in such a way as to present only those descendants who are related to each progenitor in the specified way. The resulting records are presented, along with pertinent information about each descendant.

### DETAILED DESCRIPTION OF THE INVENTION

A progenitor, or focal animal, is selected from an available record source, by means of identity or attribute information. An algorithm is enacted to trace each line of descent from the focal animal. As each descendant instance is discovered, if the descendant is not disqualified, its identity is recorded and paired with an indicator that defines the relationship of the descendant to the focal animal. This set of actions introduces a variety of embodiments of the present invention that can be outlined by addressing: the means of selecting a focal animal; the algorithm for tracing lines of descent; the qualification for recording a descendant; and the indicator of relationship to associate with a descendant.

The means of specifying the focal animal may be embodied in the following ways, but is not confined to those specifically enumerated herein. One embodiment allows for selection based on identity records such as name, registration number, and the like. Another embodiment, more helpful to a bloodline researcher who is unfamiliar with the associations between an ancestor and its characteristics, is to present a recommendation list of potential focal animals based on the researcher's ranking of a predefined set of attributes. Yet another embodiment is by hyperlink from a webpage that indicates the identity of a potential focal animal.

In the context of ancestry research, the algorithms for tracing lines of descent can be categorized into variants of pedigree research, bloodline research, or a combination of each. In its fundamental form, pedigree research undertakes to trace every possible descendant back in time through each of its lines of ancestry as far back as needed to find all instances of the focal animal. A fundamentally bloodline research approach traces each line of descent forward in time from the focal animal, so that each descendant of the focal animal is inspected for descendants, and those descendants are inspected for their own descendants, until each line of descent from the focal animal has been inspected. In one enumeration of the current invention, results of a bloodline research approach are stored for future queries of that specific focal animal. When the stored results for that specific focal animal are recalled, the database is checked for animals added after the stored result set, and the animals that were added are inspected using a combination of the pedigree research approach and the stored result set to determine the relationship to the added animals to the focal animal.

The qualification of a descendant is optional at this stage of the bloodline research process. If the selection of descendants is restricted as lines of descent are traced, the tracing process is expedited. However, the applicability of the resulting set of descendants may also become more restricted in utility. For this reason, the application of qualifying parameters will be discussed more fully in relation to comprehensive descendant relationship sets.

In each instance of descent to be recorded, an identifier of the descending animal is paired with an indicator of the descending animal's relatedness to the focal animal. The choice of which indicator of relatedness to use in a particular embodiment of this invention directly effects the specificity with which a researcher can use that embodiment of this invention to explore the relatedness of descendants to a focal animal. The more the information collected about the relationship, the more the researcher can refine the resulting enumeration of descendants. The following embodiments are but examples of the present invention which can be expressed in a multitude of other ways. For example, percentages could also be expressed as proportions, binary strings variants could also use other representations of gender and could be added from left to right instead of right to left. Other embodiments of the present invention can be constructed to capture other aspects of relatedness.

A simplistic embodiment of the present invention uses a percentage of relationship as the sole indicator of relatedness. A percentage of relationship is calculated with regard to the number of generations removed from the focal animal. For example, for first-generation progeny of the focal animal, the percentage of relationship would be 50%. Members of a second generation line of descent have a percentage of relationship of 25%, which is half of 50%. Members of a third generation line of descent, have a percentage of relationship value of 12.5%, or 25% divided by 2. In this way, any descendant in the line of descent under investigation, is given an indicator that is half the value of the indicator of its parent. If a descendant traces back to the focal animal in more than one line, the percent blood is added together to indicated the total percentage of relationship. Thus, if the focal animal is the grandmother of the descendant's father with a percentage of relationship of 12.5%, as well as the mother of the descendant's mother with an additional percentage relationship of 25%, the total percentage of relationship to the focal animal would be 37.5%. This is a common means of representing the degree to which an animal is related to an ancestor in pedigree research, and may be referred to as percent blood. A percentage of relationship is useful because it captures the combined probable genetic impact of the focal animal on each descendant, allowing for straightforward comparisons among descendants. Percentage of relationship is also of benefit in giving a single measure of relationship for each descendant.

Another embodiment of the present invention records the generations removed from the focal animal, as well as the gender of each animal identified in the line of descent under investigation, by using a binary string indication of relatedness. The binary string indication of relatedness described herein, is a variant of the Ahnentafel genealogical numbering system, in reverse. If females are represented with a 0, and males are represented with a 1, than each generation removed will have a 0 or 1 added to the end of the binary string of relatedness of its direct parent, in the line of descent under investigation. For example, a binary string indicator of relatedness of 10010 would mean that the current descendant under investigation is related to the focal animal in the line of descent under investigation through its mother, she through her father, he through his mother, she through her mother, and she through her father, her father being a son of the focal animal. In this way, a binary string indicator of relatedness identifies the exact location of an instance of the focal animal in the pedigree of the descendant under investigation. A percent of relationship can also easily be calculated from a binary string indicator of relatedness by taking the length of the binary string indicator of relatedness as n, and dividing 100% by 2 to the power of n. Furthermore, some genes are only passed along the X chromosome of a female animal so that a researcher may want to identify matrilineal descendants, which would be all the descendants with only 0's in their binary string indication of relatedness, as described above. If a researcher wants to identify animals that descend in multiple lines from the focal animal, through at least one son of the focal animal and one daughter of the focal animal, than descendants with at least one binary string indication of relatedness starting with a 1 and one binary string indication of relatedness starting with a 0 could be selected.

The present invention may also be embodied to capture the relatedness of descendants to a focal animal by recording the identity of animals in the lines of descent between the focal animal and descendant being investigated. This allows a researcher to focus on specific branches among the lines of descent from a focal animal.

In response to the first previously existing problem set out in paragraph 6, a percentage table provides a means by which to compare between all recorded descendants of a chosen focal animal by percent blood. As such, it can be used in conjunction with any other record set that provides additional information about animals contained in the percentage table constructed for the focal animal. For example, when combined with records of birth date, all animals that are within an age group, can be singled out and sorted by highest percent blood in descending order. If the age group covers the maximum life-span of the species, then the first animal that can be verified to be living, is the highest surviving percent blood carrier of the focal animal. Identifying animals carrying a high percent blood is useful to anyone wishing to increase a particular animal's contribution to the population and thus increase the homogeneity of the desirable traits associated with that animal. Conversely, it is also useful to anyone trying to cull the genetics of an undesired animal from the population.

Having established the relationship of a comprehensive set of recorded descendants to a chosen focal animal, further embodiments of the present invention add utility to descendant relation record sets by combining added information about the descendants. This information is useful in researching bloodlines to identify animals of interest. For example, in one embodiment of the present invention, the age of the descendants are restricted to a given birth year. If the descendants born in said year, are ordered in descending order of percent relationship, the first animal listed will be the animal that carries the highest percent blood of that year. In like manner, restriction to only living animals will reveal the highest percent blood descendant alive. Useful qualifying parameters may include, but are not restricted to characteristics of circumstance, genetics, and achievement.

Circumstantial characteristics may include, but are not restricted to, things such as name, age, owner and breeder.

Genetic characteristics of interest may include, but are not restricted to, phenotypic parameters such as gender and color, or genotypic parameters such as inheritable disorders.

Characteristics of achievement may include, but are not restricted to, things that the animal accomplishes, whether by action, assessment by a judge, or both.

When descendant relation record sets are combined, the second limitation of pedigree research defined in paragraph [0006] is overcome. A researcher can hereby select a set of focal animals, and specify parameters for each focal animal that restrict the set of descendants to include only those who are related to the set of focal animals in the ways allowed by the parameters.

For example, in one embodiment of the present invention, if a researcher wants to find all of the animals descending from focal animal A with a percentage blood equivalent to that of at least a great-grandparent, and descending from focal animal B with a percentage blood equivalent to that of at least a great-great-grandparent, they would set a range of percent blood for focal animal A to be 12.5% or greater and the percent blood for focal animal B to be 6.25% or greater. All of the animals in the available record source who had at least 12.5% blood from focal animal A, and at least 6.25% blood from focal animal B would be indicated.

In another embodiment of the present invention, parameters are set to constrain binary string indicators of relatedness for each focal animal, such that a researcher specifies the pedigree positions in which each focal animal is to be found. Those descendants of every focal animal whose binary string indicators placed it in correct relationship to each focal animal would be indicated.

Another embodiment of the present invention allows the relationships of focal animals to their descendants, to be embodied in percentage blood and the identities of the animals along each line of descent. The descendants of each focal animal, that carries the percent blood, and descends through the animals prescribed by the relevant parameter set, would be indicated.

An embodiment of the best mode contemplated for the above inventions, relies on the processing power and data storage capabilities of a computer. The breeding records are stored in a relational database management system and are processed using structured query language constructs. The researcher is enabled to interact with the invention through a graphical user interface presented by an internet server addressed to a uniform resource locator. When called to iterate through the hierarchically structured database of breeding records, a stored procedure applies a recursive common table expression to implement the bloodline research approach. When all lines of descent have been inspected, any multiple records of the same descendant (those tracing to the focal animal through more than one line of descent) are combined into one record. The indicators of percent blood for that descendant are summed together to give a cumulative percentage of blood carried. Thus a record set is constructed that presents a single record for each descendant paired with that descendant's indicator of percent blood carried. This record set constitutes what will be referred to herein as a percentage table. The resulting percentage tables are then presented as a sortable list along with information about each descendants characteristics of birth year, name, parentage, color, and gender. Table 1 presents a recursive common table expression written to be utilized as a stored procedure within a Microsoft SQL Server relational database management system context.

TABLE 1
Recursive common table expression to create a percentage
table from a parentage type database

```
GO
SET QUOTED_IDENTIFIER ON
GO
ALTER PROCEDURE [dbo].[pct]
@id int
AS
BEGIN
SET NOCOUNT ON;
WITH PctCTE(id, pt, gn, yr, ct)
AS
  (SELECT animal_id, CONVERT(DECIMAL(28,25),100.0) AS pt,
  gender, birth_yr, 1
  FROM dbo.animals parent
  WHERE parent.animal_id = @id
  UNION ALL
  SELECT child.animal_id, CONVERT(DECIMAL(28,25),parent.pt/2.0),
child.gender, child.birth_yr, parent.ct+1
  FROM dbo.animals AS child
  INNER JOIN PctCTE AS parent
  ON (parent.gn = ‘M’ AND
  (child.mom_id = parent.id))
  OR
  (NOT parent.gn = ‘M’ AND
  (child.dam_id = parent.id))
  ),
  mergeCTE(dups, h, p, y)
  AS
  (SELECT ROW_NUMBER ( ) OVER (PARTITION BY id ORDER
BY ct) ‘dups’, id, SUM(pt) OVER (PARTITION BY id), yr
  FROM PctCTE
  )
  SELECT tmp.h , CONVERT(FLOAT,tmp.p) ‘Percentage’, tmp.y ‘Born’,
h.animal_nm ‘Name’, ‘( ‘+ h.dad_nm + ‘X’ +
h.mom_nm + ’ )’ ‘Breeding’, h.color ‘Color’, h.gender ‘Gndr’
  FROM mergeCTE AS tmp
  LEFT JOIN animals AS h
  ON tmp.h = h.animal_id
  WHERE dups = 1
  ORDER BY Born DESC, Percentage DESC
END
```

Percentage tables of focal animals can also be combined together to indicate the animals on record that contain all of the selected focal animals in their recorded ancestry. A desired range of percent blood is established for each selected focal animal using a graphical user interface on a dedicated webpage. A structured query language construct called “SELECT” is used to choose the animals in each percentage table that meet the established percent blood requirements for each focal animal. These percentage table subsets are combined using another structured query language construct known as an “INNER JOIN.” The resulting blend of percentage tables contain only those descendants of each focal animal that embody the desired blend of focal animals in the amount of percent blood specified. In this way a researcher can find all of the animals, in a given data source, which carry any desired blend of focal animals in any specified amount.

Although illustrative embodiments of the present invention have been described herein, please understand that the present invention is not limited to these precise embodiments, and that various other changes and modifications may be affected therein by one skilled in the art without departing from the scope or spirit of the present invention.

I claim:

1. A method, or a computer executable code capable of executing a method, that provides for an analysis of a record set of generational relatedness amongst animals, comprising the steps of:
a) tracing, or providing for the tracing of, the descendants of a progenitor, along an enumeration of its lines of descent;
b) recording, or providing for the recording of, an element of information about the relationship of each descendant to said progenitor.

2. A method, or a computer executable code capable of executing a method, according to claim 1, wherein the progenitor comprises:
a) any specifiable progenitor contained within the record set of generational relatedness amongst animals; or
b) any specifiable progenitor contained within a subset of the record set of generational relatedness amongst animals.

3. A method, or a computer executable code capable of executing a method, according to claim 2, wherein the subset of the record set of generational relatedness amongst animals comprises:
a) more than three generations of information; or
b) more encompassing than patrilineal, or matrilineal relatedness; or
c) more than a pedigree of a single descendant.

4. A method, or a computer executable code capable of executing a method, according to claim 1, wherein the enumeration of the progenitor's lines of descent comprises:
a) all recorded lines of descent from the progenitor; or
b) all recorded lines of descent from the progenitor in which descendants, or lines of descent, are qualified by characteristic.

5. A method, or a computer executable code capable of executing a method, according to claim 1, wherein the enumeration of the progenitor's lines of descent comprises:
a) a form of pedigree research that examines more than one animal's pedigree; or
b) a form of bloodline research; or
c) a combination of a pedigree research approach that examines more than one animal's pedigree, and a bloodline research approach.

6. A method, or a computer executable code capable of executing a method, according to claim 1, wherein the element of information about the relationship of each descendant to said progenitor comprises:
a) a quantification of the amount of genetic material inherited from the progenitor; or
b) a statistical approximation to the amount of genetic material inherited from the progenitor.

7. A method, or a computer executable code capable of executing a method, according to claim 1, wherein the element of information about the relationship of each descendant to said progenitor comprises:
a) a qualification of the path through which genetic material is inherited from the progenitor; or
b) an indication of the path through which genetic material is inherited from the progenitor.

8. A method, or a computer executable code capable of executing a method, according to claim 1,
wherein the analysis of a record set of generational relatedness amongst animals is augmented with an additional step to comprise:
the inclusion of, or providing for the inclusion of, an element of information about characteristics of said descendants considered to facilitate the selection or assessment of those descendants.

9. A method, or a computer executable code capable of executing a method, according to claim 8,
wherein the element of information about characteristics of said descendants considered to facilitate the selection or assessment of those descendants comprises:
a) characteristics of circumstance such as name, birth date, owner, breeder, or relation; or
b) characteristics of phenotype, or genotype; or
c) characteristics of achievement such as accomplishments of the animal by its actions, or accomplishments bestowed upon the animal by judgments of an assessor.

10. A method, or a computer executable code capable of executing a method, according to claim 8,
wherein the element of information about characteristics of said descendants considered to facilitate the selection or assessment of those descendants comprises:
a collection of relationship information defining the relatedness of said descendants to at least one additional progenitor.

11. A method, or a computer executable code capable of executing a method, according to claim 10, wherein the collection of relationship information defining the relatedness of said descendants to at least one additional progenitor comprises:
a means of identifying those descendants whose specificity of relatedness to a progenitor satisfies a set of parameters corresponding to that progenitor.

12. A method, or a computer executable code capable of executing a method, according to claim 11, wherein the set of parameters corresponding to that progenitor comprises:
a) parameters determined by an algorithm; or
b) parameters determined by user selection, either directly or indirectly; or
c) parameters determined by the information provider.
